(19) United States
(12) Patent Application Publication
(10) Pub. No.: US 2022/0210727 A1
(43) Pub. Date: Jun. 30, 2022

(54) VOICE CALL INITIATION METHOD, TERMINAL DEVICE AND COMPUTER READABLE STORAGE MEDIUM

(71) Applicant: GUANGDONG OPPO MOBILE TELECOMMUNICATIONS CORP., LTD., Dongguan (CN)

(72) Inventors: Xin XU, Palo Alto, CA (US); Yongsheng SHI, Palo Alto, CA (US)

(21) Appl. No.: 17/696,598

(22) Filed: Mar. 16, 2022

Related U.S. Application Data
(63) Continuation of application No. PCT/CN2020/116217, filed on Sep. 18, 2020.
(60) Provisional application No. 62/927,299, filed on Oct. 29, 2019.

(51) Int. Cl. H04W 48/18; H04W 8/18

(52) U.S. Cl. CPC H04W 48/18; H04W 8/183

(57) ABSTRACT

The present disclosure provide a voice call initiation method, a terminal device and a computer readable storage medium. The voice call initiation method may include: determining a SUB order list with its suitable SUBs; determining orders of Radio Access Technologies (RATs) in each SUB; selecting a first SUB for a voice call from the SUB order list in order and a first RAT within the first SUB according to the orders of RATs in the first SUB and initiating the voice call with the first SUB and the first RAT.

### CROSS-REFERENCE TO RELATED APPLICATION

This application is a continuation application of International Patent Application No. PCT/CN2020/116217, filed Sep. 18, 2020, which claims priority to U.S. Provisional Patent Application No. 62/927,299, filed Oct. 29, 2019, the entire disclosures of which are incorporated herein by reference.

### TECHNICAL FIELD

The present disclosure relates to the field of wireless communication technologies, and more particularly, to a voice call initiation method, a terminal device and a computer readable storage medium.

### BACKGROUND

Normal voice call (non-emergency call) is the most essential service of cell phone. It is very important to make each call attempt succeed as much as possible.

Currently all cellular device (cell phone or other mobile device which is capable of voice call, referred as UE (User Equipment) below) supports at least one SIM (Subscriber Identity Module) (i.e. SUB, in this disclosure, SUB and SIM refer to the same object) card (either embedded SIM/software SIM) and each SUB it supports multiple radio technologies (like 5G/LTE/WCDMA/TD-SCDMA/GSM/CDMA/WIFI), referred as RAT (Radio Access Technology) below). Normal call usually is originated with the user designated SUB (user specified) or default SUB (if user doesn't specify), which may be not the best choice at the time (unless user has specific reason to limit the call with the SUB). And UE modem decides the RAT to originate within the SUB and retry in some failure cases (non-network reject cause).

It is observed that normal call failed and UE doesn't retry on other supported SUB or RATs of same SUB, if certain failures (like reject from network) happened, which is not good experience to user.

The above information disclosed in this Background section is only for enhancement of understanding of the background of the disclosure and therefore it may contain information that does not form the prior art that is already known in this country to a person of ordinary skill in the art.

### SUMMARY

The present disclosure provides a voice call initiation method and device.

In a first aspect, the present disclosure provides a voice call initiation method, which may include: determining a SUB order list with its suitable SUBs; determining orders of Radio Access Technologies (RATs) in each SUB; selecting a first SUB for a voice call from the SUB order list in order and a first RAT within the first SUB according to the orders of RATs in the first SUB; and initiating the voice call with the first SUB and the first RAT.

In a second aspect, the present disclosure provides a terminal device, including a processor and a memory; wherein the memory is configured to store instructions executable by the processor and the processor is configured to execute a voice call initiation method. The method may include: determining, by the terminal device, a SUB order list with its suitable SUBs; determining, by the terminal device, orders of Radio Access Technologies (RATs) in each SUB; selecting, by the terminal device, a first SUB for a voice call from the SUB order list in order and a first RAT within the first SUB according to the orders of RATs in the first SUB; and initiating, by the terminal device, the voice call with the first SUB and the first RAT.

In a third aspect, the present disclosure provides a computer readable medium having instructions stored thereon. When executed by a processor, the instruction may execute the steps of a voice call initiation method. The method may include: determining, by a terminal, a SUB order list with its suitable SUBs; determining, by the terminal, orders of Radio Access Technologies (RATs) in each SUB; selecting, by the terminal, a first SUB for a voice call from the SUB order list in order and a first RAT within the first SUB according to the orders of RATs in the first SUB; and initiating, by the terminal, the voice call with the first SUB and the first RAT.

This section provides a summary of various implementations or examples of the technology described in the disclosure, however, it is not a comprehensive disclosure of the full scope or all features of the disclosed technology.

### BRIEF DESCRIPTION OF THE DRAWINGS

To describe the technical solutions in the embodiments of the present disclosure more clearly, the following will briefly introduce the accompanying drawings required for describing the embodiments of the present disclosure. Apparently, the accompanying drawings in the following description show merely some embodiments of the present disclosure, and a person of ordinary skill in the art may still derive other drawings from these accompanying drawings without creative efforts.

FIG. 1 schematically illustrates a flowchart of a voice call initiation method according to an embodiment of the present disclosure.

FIG. 2 schematically illustrates a flowchart of a voice call initiation method according to another embodiment of the present disclosure.

FIG. 3 schematically illustrates a flowchart of a voice call initiation method according to another embodiment of the present disclosure.

FIG. 4 schematically illustrates a flowchart of a voice call initiation method according to another embodiment of the present disclosure.

FIG. 5 schematically illustrates a flowchart of a voice call initiation method according to another embodiment of the present disclosure.

FIG. 6 schematically illustrates a flowchart of a voice call initiation method according to another embodiment of the present disclosure.

FIG. 7 schematically illustrates a terminal according to an embodiment of the present disclosure.

FIG. 8 schematically illustrates a terminal device according to an embodiment of the present disclosure.

### DETAILED DESCRIPTION

Exemplary embodiments of the disclosure will now be described more fully with reference to the accompanying drawings, in which exemplary embodiments are shown. Exemplary embodiments of the disclosure may, however, be embodied in many different forms and should not be construed as being limited to the embodiments set forth herein; rather, these embodiments are provided so that this disclosure will be thorough and complete, and will fully convey the concept of exemplary embodiments to those skilled in the art. In the drawings, the thicknesses of layers and regions are exaggerated for clarity. Like reference numerals in the drawings denote like elements, and thus their description will be omitted.

The described features, structures, or/and characteristics of the disclosure may be combined in any suitable manner in one or more embodiments. In the following description, numerous specific details are disclosed to provide a thorough understanding of embodiments of the disclosure. One skilled in the relevant art will recognize, however, that the disclosure may be practiced without one or more of the specific details, or with other methods, components and so forth. In other instances, well-known structures, materials, or operations are not shown or described in detail to avoid obscuring aspects of the disclosure.

As mentioned above, a normal call usually is originated with the user designated SUB (user specified) or default SUB (if user doesn't specify), which may be not the best choice at the time. And when the normal call fails, the UE usually doesn't retry on other supported SUB or RATs of the same SUB.

Below are few failure examples:

TABLE 1

| | Sub1 | Sub1 | Sub2 | Sub2 | User | |
|---|---|---|---|---|---|---|
| | Service | Service | Service | Service | selected | |
| Case | Status | RAT | Status | RAT | SUB | Failure Observation |
| 1 | Normal | LTE | Limited | GSM | Sub2 | Selecting sub 2 which doesn't have |
| | | | | | | normal service will lead to modem to |
| | | | | | | search the network (which will |
| | | | | | | increase delay) and if no normal |
| | | | | | | service obtained later call will fail. |
| 2 | OOS | N/A | Normal | WCDMA | Sub1 | Sub1 is out of Service and will need |
| | | | | | | to scan/camp on network before |
| | | | | | | making the call; additional delay will |
| | | | | | | be introduced and if no normal |
| | | | | | | service obtained later call will fail. |
| 3 | Normal | LTE | Normal | WCDMA | Sub1 | In case Sub1 LTE network reject call |
| | | | | | | request, there is no retry on other |
| | | | | | | RAT (like WCDMA or WIFI) of |
| | | | | | | SUB1 or SUB2 and cause final call |
| | | | | | | failure. |

In above failure examples it could been seen mainly two aspects which can be optimized:
1. The initial SUB/RAT selection (to give best chance for first shot);
2. Retry mechanism if any failure (so that the call can be succeed in alternative SUB/RAT).

In the present disclosure, a complete solution, from initial SUB/RAT selection to retry mechanism to allow the UE to accomplish the call at the earliest and improve successful rate with all possible combination of SUB/RAT that UE supported, is provided.

It is to be understood that the technical solutions of the present disclosure may be used in various wireless communication systems, for example, Global System of Mobile communication (GSM), General Packet Radio Service (GPRS), Wideband Code Division Multiple Access (WCDMA), High-Speed Packet Access (HSPA), LTE, LTE-Advanced (LTE-A), New Radio (NR) and so on. Furthermore, the communication between a terminal and a network device in the wireless communication network may be performed according to any suitable generation communication protocols, including, but not limited to, the second generation (2G), 2.5G, 2.75G, the third generation (3G), the fourth generation (4G), 4.5G, the fifth generation (5G) communication protocols, and/or any other protocols either currently known or to be developed in the future.

It is to be understood that the term “terminal” refers to any end device that can access a wireless communication network and receive services therefrom. The terminal may include user equipment (UE), which is also referred to as a mobile terminal or mobile user equipment and so on. The user equipment may be a mobile terminal such as a mobile telephone (also referred to as a cellular telephone) or a computer having a mobile terminal such as portable, pocket, hand-held, vehicle-mounted mobile apparatuses or a mobile apparatus with a built-in computer.

It is to be understood that the term “network device” refers to a device in a wireless communication network via which a terminal accesses the network and receives services therefrom. The network device may include a base station (BS), an access point (AP), a Mobile Management Entity (MME), a Multi-cell/Multicast Coordination Entity (MCE), a Access and Mobility Management Function (AMF)/User Plane Function (UPF), a gateway, a server, a controller or any other suitable device in the wireless communication network. The BS may be, for example, a base transceiver station (BTS) in the GSM or the CDMA, or may be a Node B in the WCDMA, or may be an evolutional Node B (eNB or e-NodeB) in the LTE or the LTE-A, or may be a gNB or ng-eNB in the NR, and the present disclosure is not limited thereto.

In some embodiments, a voice call initiation method may include: determining, by a terminal, a SUB order list with its suitable SUBs; determining, by the terminal, orders of Radio Access Technologies (RATs) in each SUB; selecting, by the terminal, a first SUB for a voice call from the SUB order list in order and a first RAT within the first SUB according to the orders of RATs in the first SUB; and initiating, by the terminal, the voice call with the first SUB and the first RAT.

In some embodiments, the determining, by the terminal, the SUB order list with its suitable SUBs may include: excluding, by the terminal, unsuitable SUB by checking its SIM type or its voice domain capability; and ordering, by the terminal, the suitable SUBs by priority in the SUB order list.

In some embodiments, the determining, by the terminal, the SUB order list with its suitable SUBs may further include: determining, by the terminal, priorities of the suitable SUBs according to service status of each SUB firstly and then RAT domain of each SUB.

In some embodiments, the determining, by the terminal, priorities of the suitable SUBs according to service status of each SUB firstly and then RAT domain of each SUB may include: determining, by the terminal, the suitable SUB selected by user has the highest priority when all suitable SUBs have the same service status.

In some embodiments, the determining, by the terminal, the orders of RATs within each SUB may include: determining, by the terminal, the orders of RATs which starts from the current service RAT, within each SUB.

In some embodiments, the determining, by the terminal, the orders of RATs within each SUB may further include: selecting, by the terminal, only one highest priority RAT from each pre-defined group other than the current service RAT, within each SUB.

In some embodiments, the pre-defined groups may include: circuit switching (CS) cellular RAT group, packet switching (PS) cellular RAT group and non-cellular RAT group.

In some embodiments, the CS cellular RAT group may include at least one of the following RATs: Wideband Code Division Multiple Access (WCDMA), Time Division-Synchronization Code Division Multiple Access (TD-SCDMA), Global System for Mobile Communications (GSM) and Code Division Multiple Access (CDMA); the PS cellular RAT group includes at least one of the following RATs: Long Term Evolution (LTE) and new radio (NR); the non-cellular RAT group includes WIFI.

In some embodiments, the determining, by the terminal, the orders of RATs within each SUB may include: determining, by the terminal, the orders of RATs which starts from the highest priority RAT, within each SUB.

In some embodiments, RAT priority within each SUB may be configured by network device or operator.

In some embodiments, the determining, by the terminal, the orders of RATs within each SUB may include: determining, by the terminal, the orders of RATs which starts from automatic service type RAT first and then follows CS service type RAT, within each SUB.

In some embodiments, the CS service RAT may include at least one of the following RATs: WCDMA, TD-SCDMA, CDMA and GSM.

In some embodiments, the voice call initiation method may include: re-selecting, by the terminal, a second RAT and/or a second SUB for retrying the voice call when a failure of the voice call occurs with the first SUB and the first RAT.

In some embodiments, the re-selecting, by the terminal, the second RAT and/or the second SUB may include: re-selecting, by the terminal, the second SUB from the SUB order list in order when the failure of the voice call occurs with the first SUB and the first RAT.

In some embodiments, the re-selecting, by the terminal, the second RAT and/or the second SUB may further include: selecting, by the terminal, the second RAT within the second SUB according to the orders of RATs in the second SUB.

In some embodiments, the re-selecting, by the terminal, the second RAT and/or the second SUB may include: re-selecting, by the terminal, the second RAT within the first SUB according to the orders of RATs in the first SUB.

In some embodiments, a terminal may include a determining unit, a selecting unit and an initiating unit. The determining unit may be configured to determine a SUB order list with its suitable SUBs and orders of RATs in each SUB. The selecting unit may be configured to select a first SUB for a voice call from the SUB order list in order and a first RAT within the first SUB according to the orders of RATs in the first SUB. The initiating unit may be configured to initiate the voice call with the first SUB and the first RAT.

In some embodiments, a terminal device may include a processor and a memory. The memory may be configured to store instructions executable by the processor. The processor may be configured to execute the steps of the above-mentioned voice call initiation method.

In some embodiments, a computer readable storage medium having instructions stored thereon may be provided. The instructions when being executed by a processor may execute the steps of the above-mentioned voice call initiation method.

In some embodiments, a computer program product may include a non-transitory computer-readable storage medium storing a computer program. The computer program may be executable to cause a computer to execute the steps the above-mentioned voice call initiation method.

With reference to the accompanying drawings, A voice call initiation method and equipment provided by the embodiments of the present disclosure will be specifically described below.

The embodiments of the present disclosure include at least parts of the following contents.

The whole proposal will include below two aspects mainly:
1. The initial SUB/RAT selection;
2. Retry on same SUB/other SUB if any failure.

It can be understood that user may want to stick to designated SUB to dial the call first, so there are two modes (which contains different part) available:
Full mode: where UE will decide the best SUB/RAT (which may be different with the user selected SUB) to originate the call first and retry on other SUB/RAT if needed; this includes both parts:
   Initial SUB/RAT selection
   Retry mechanism (same SUB/other SUB)
Partial mode: where UE will always start from the SUB that the user selected, and retry on other SUB/RAT if needed; this only includes one part:
   Retry mechanism (same SUB/other SUB)
Initial SUB/RAT selection
When user originates the normal voice call, the UE selects the SUB/RAT based on designed priority as below and generate list to follow.
   For SUB selection, generate SUB Order List by excluding unsuitable SUB and order the SUBs by priority.
      Exclude unsuitable SUB by checking SIM type or voice domain capability.
      Need check if SUB been selected has SIM card which doesn't support voice service (this can be done via SIM type or voice domain capability of the SUB, like some SIM is for internet data service only, then not suitable for normal voice call origination and exclude it).
      Order the SUBs by priority.
      If there is more than one SUB (with SIM) suitable after previous check, we need order the SUB by priority as below.
         When define SUB priority, service status is first factor and then RAT domain.
         Normal service has better chance of success for normal voice call.
         We take SUB service status as major factor for priority (normal service>limited service>no service). If all SUBs have same service status, user selected RAT priority is provided and other SUB follows.
         Below are some examples how the final SUB order list look like:

TABLE 2
SUB order list examples

| | Sub1 | Sub1 | Sub2 | Sub2 | |
|---|---|---|---|---|---|
| | Service | Service | Service | Service | Sub Order |
| Case | Status | RAT | Status | RAT | List |
| 1 | Normal | LTE | Limited | GSM | Sub1 > Sub2 |
| 2 | OOS | N/A | Limited | WCDMA | Sub2 > Sub1 |
| 3 | Normal | LTE | Normal | WCDMA | Sub2 > Sub1 |
| | | | | | (user selected |
| | | | | | Sub2) |
| 4 | Normal | LTE (SIM | Normal | LTE | Sub2 |
| | | not for voice | | | |
| | | support) | | | |

For RAT selection, there are two options.
Now it is needed to decide the RAT order to originate within each SUB.
There are 3 options to decide the RAT order:
1. Start from current service RAT
2. Start from highest Priority RAT
3. Start from RAT modem decided automatically
   Start from service RAT first
   This can avoid RAT switch which will introduce more delay.
   UE will always try on the current service RAT first, then other RATs UE supported.
   This can be further divided to two options:
      Selective RAT mode
      All RATs (LTE/WCDMA/TD-SCDMA/GSM/CDMA/5G/WIFI) will be divided into 3 groups: CS cellular RAT (WCDMA/TD-SCDMA/GSM CDMA), PS cellular RAT (LTE/5G), and non-cellular RAT (WIFI).
      Only one highest priority RAT from each group is selected to try (other than the current service RAT).
      For example, in case 1 of table 2: for SUB1, the RAT order will be LTE (Service RAT&PS cellular RAT)/WCDMA (CS cellular RAT)/WIFI (if Voice over WIFI available); for SUB2, the RAT order is GSM (Service RAT&CS cellular RAT)/LTE (PS cellular RAT)/WIFI (if Voice over WIFI available).
      All RATs mode
      It will start from service RAT and go through all supported RATs within the SUB. It will try all possible SUB/RAT combinations and may add some delay before switching SUB.
      For example, in case 1 of table 2: for SUB1, the RAT order will be LTE (Service RAT)/WCDMA/TD-SCDMA/GSM/CDMA/5G (if supported)/WIFI (if Voice over WIFI available); for SUB2, the RAT order is GSM (Service RAT)/LTE/WCDMA/TD-SCDMA/CDMA/5G (if supported)/WIFI (if Voice over WIFI available).
   Start from highest priority RAT first
   It will always start from the highest priority RAT which means RAT switching may happen (if current RAT is not the highest priority RAT). The RAT priority definition can be network (operator) dependent and pre-defined.
   For GSM operator, it can be WCDMA/GSM/LTE/TD-SCDMA (if supported)/5G (if supported)/WIFI (if Voice over WIFI available).
   For CDMA operator, it can be CDMA/LTE/WIFI (if Voice over WIFI available).
   Start from automatic service type first then CS service type (if not tried)
   Let UE modem to decide the RAT (it can be current RAT first or not (like CS fallback case)) automatically first, if call failed then switch to CS only RAT (GSM/WCDMA/CDMA/TD-SCMDA). If CS RAT already tried in AUTO mode then no need to switch to CS RAT after failure.
   Then with SUB and RAT order decided, UE will have one origination order list ready (below example is for option 3: Start from RAT modem decided automatically), UE can try next item if one failed.

TABLE 3
RAT selection examples

| | Sub1 | Sub1 | Sub2 | Sub2 | Sub | Sub |
|---|---|---|---|---|---|---|
| | Service | Service | Service | Service | Priority | Originating |
| Case | Status | RAT | Status | RAT | List | Order |
| 1 | Normal | LTE | Limited | GSM | Sub1 > | Sub1(AUTO) > |
| | | | | | Sub2 | Sub1(CS) > |
| | | | | | | Sub2(AUTO) |
| 2 | OOS | N/A | Limited | WCDMA | Sub2 > | Sub2(AUTO) > |
| | | | | | Sub1 | Sub1(AUTO) > |
| | | | | | | Sub1(CS) |
| 3 | Normal | LTE | Normal | WCDMA | Sub2 > | Sub2(AUTO) > |
| | | | | | Sub1 | Sub1(AUTO) > |
| | | | | | | Sub1(CS) |
| 4 | N/A | N/A | Normal | WCDMA | Sub2 | Sub2(AUTO) |

Retry mechanism (same SUB/other SUB)
When modem reports normal call originating failure for specified SUB+RAT (sub (RAT)), based on reason UE could switch RAT or SUB.
Here there are two options to retry, and it can be switch RAT within SUB first, or switch SUB first.
   Switch RAT first
   IF the call originating order is: Sub1 (AUTO)>Sub1 (CS)>Sub2 (AUTO)>Sub2 (CS)>VoWifi (if available).
   If failure is reported after Sub1 (AUTO), UE would try next entry Sub1 (CS) if during AUTO mode CS RAT is not tried.
   For certain failure reason (core network reject), UE may skip to a different sub (like from Sub1 (AUTO) to Sub2 (AUTO)). Call over VoWIFI (WIFI calling) can be tried if all attempts over cellular failed and VoWIFI is available. Or UE could try VoWIFI first then try cellular call.
   Switch SUB first
   If the call originating order is: Sub1 (AUTO)>Sub1 (CS)>Sub2 (AUTO)>Sub2 (CS)>VoWifi.
   If failure is reported after Sub1 (AUTO), UE would try other SUB first Sub2 (AUTO) then VoWifi. If it still failed, UE could go back to retry Sub1 (CS) then other alternatives.
Proposal 1.3: In above we list VoWifi (WIFI calling) as one RAT option to increase the chance of success.
If VoWIFI (WIFI calling) is available, UE could try this option first then cellular or vice versa.

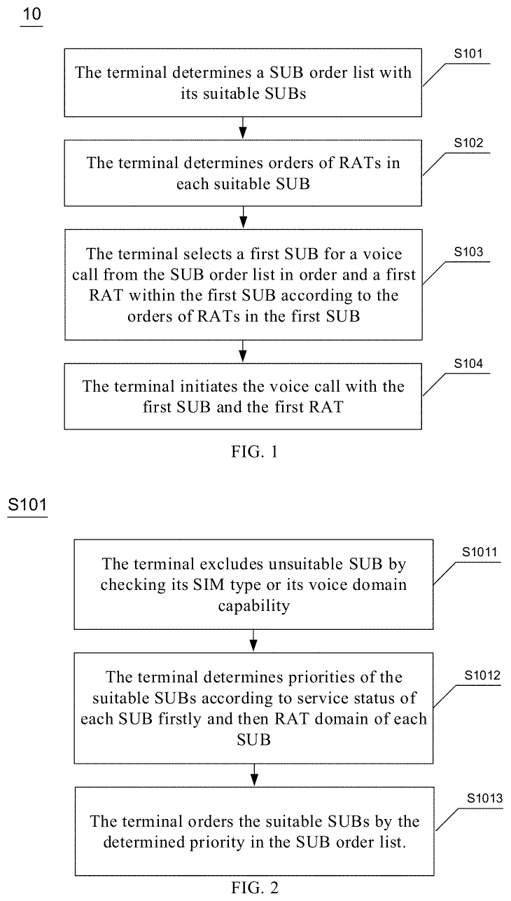

FIG. 1 schematically illustrates a flowchart of a voice call initiation method according to an embodiment of the present disclosure. The method may be applied, for example, to a terminal. The terminal may be a UE in above-mentioned wireless communication systems.

Referring to FIG. 1, the voice call initiation method 10 comprises:

In Step S101, the terminal determines a SUB order list with its suitable SUBs.

The terminal needs to check whether a SUB has SIM card which does not support voice service or not. And when the SIM card in a SUB does not support voice service, the SUB is considered an unsuitable SUB.

In Step S102, the terminal determines orders of RATs in each suitable SUB.

In Step S103, the terminal selects a first SUB for a voice call from the SUB order list in order and a first RAT within the first SUB according to the orders of RATs in the first SUB.

In Step S104, the terminal initiates the voice call with the first SUB and the first RAT.

The embodiments of the present disclosure provide a voice call initiation method. In this method, the terminal may select initial SUB/RAT to accomplish a voice call at the earliest and improve successful rate with all possible combination of SUBs/RATs that the terminal supports.

FIG. 2 schematically illustrates a flowchart of a voice call initiation method according to another embodiment of the present disclosure.

As shown in FIG. 2, Step S101 may comprise:

In Step S1011, the terminal excludes unsuitable SUB by checking its SIM type or its voice domain capability.

In Step S1012, the terminal determines priorities of the suitable SUBs according to service status of each SUB firstly and then RAT domain of each SUB.

Normal service has better chance of success for normal voice call.

SUB service status is taken as major factor for priority (normal service>limited service>no service).

In an embodiment of the present disclosure, the terminal determines the suitable SUB selected by user has the highest priority when all suitable SUBs have the same service status.

Abovementioned Table 2 shows some example how the final SUB order list looks like.

In Step S1013, the terminal orders the suitable SUBs by the determined priority in the SUB order list.

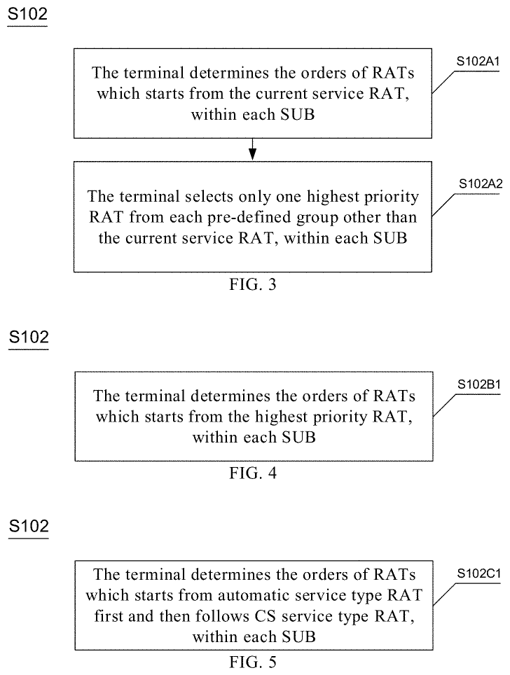

FIG. 3 schematically illustrates a flowchart of a voice call initiation method according to another embodiment of the present disclosure.

As shown in FIG. 3, Step S102 comprises:

In Step S102A1, the terminal determines the orders of RATs which starts from the current service RAT, within each SUB.

This can avoid RAT switch which will introduce more delay. For example, the terminal will always try on the current service RAT first, then other RATs UE supported.

In an embodiment of the present disclosure, Step S102 further comprise:

In Step S102A2, the terminal selects only one highest priority RAT from each pre-defined group other than the current service RAT, within each SUB.

In an embodiment of the present disclosure, the pre-defined groups include: circuit switching (CS) cellular RAT group, packet switching (PS) cellular RAT group and non-cellular RAT group.

In an embodiment of the present disclosure, the CS cellular RAT group includes at least one of the following RATs: WCDMA, TD-SCDMA, GSM and CDMA; the PS cellular RAT group includes at least one of the following RATs: LTE and NR; the non-cellular RAT group includes WIFI.

For example, in case 1 of table 2: for SUB1, the RAT order will be LTE (Service RAT)/WCDMA/TD-SCDMA/GSM/CDMA/5G (if supported)/WIFI (if Voice over WIFI available); for SUB2, the RAT order is GSM (Service RAT)/LTE/WCDMA/TD-SCDMA/CDMA/5G (if supported)/WIFI (if Voice over WIFI available).

FIG. 4 schematically illustrates a flowchart of a voice call initiation method according to another embodiment of the present disclosure.

As shown in FIG. 4, Step S102 may comprise:

In Step S102B1, the terminal determines the orders of RATs which starts from the highest priority RAT, within each SUB.

In an embodiment of the present disclosure, RAT priority within each SUB is configured by network device or operator.

For GSM operator, it can be WCDMA/GSM/LTE/TD-SCDMA (if supported)/5G (if supported)/WIFI (if Voice over WIFI available).

For CDMA operator, it can be CDMA/LTE/WIFI (if Voice over WIFI available).

FIG. 5 schematically illustrates a flowchart of a voice call initiation method according to another embodiment of the present disclosure.

As shown in FIG. 5, Step S102 may comprise:

In Step S102C1, the terminal determines the orders of RATs which starts from automatic service type RAT first and then follows CS service type RAT, within each SUB.

In an embodiment of the present disclosure, the CS service RAT includes at least one of the following RATs: WCDMA, TD-SCDMA, CDMA and GSM.

For example, let UE modem to decide the RAT (it can be current RAT first or not (like CS fallback case)) automatically first, if call failed then switch to CS only RAT (GSM/WCDMA/CDMA/TD-SCMDA). If CS RAT already tried in AUTO mode then no need to switch to CS RAT after failure.

In an embodiment of the present disclosure, with SUB and RAT order decided, UE will have one origination order list ready (as shown in Table 3), UE can try next item if one failed.

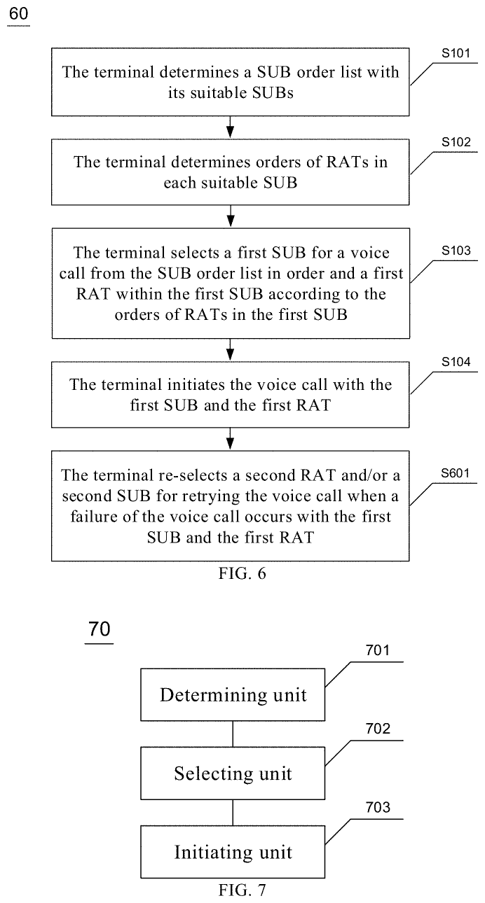

FIG. 6 schematically illustrates a flowchart of a voice call initiation method according to another embodiment of the present disclosure.

As shown in FIG. 6, the voice call initiation method 60 may further comprise:

In Step S601, the terminal re-selects a second RAT and/or a second SUB for retrying the voice call when a failure of the voice call occurs with the first SUB and the first RAT.

In an embodiment of the present disclosure, Step S601 may comprise: the terminal re-selects the second SUB from the SUB order list in order when the failure of the voice call occurs with the first SUB and the first RAT; and the terminal selects the second RAT within the second SUB according to the orders of RATs in the second SUB.

For example, the call originating order is: Sub1 (AUTO)>Sub1 (CS)>Sub2 (AUTO)>Sub2 (CS)>VoWifi. If failure is reported after Sub1 (AUTO), the terminal would try other SUB first Sub2 (AUTO) then VoWifi. If it still failed, the terminal could go back to retry Sub1 (CS) then other alternatives.

In an embodiment of the present disclosure, Step S601 may comprise: the terminal re-selects the second RAT within the first SUB according to the orders of RATs in the first SUB.

For example, the call originating order is: Sub1 (AUTO)>Sub1 (CS)>Sub2 (AUTO)>Sub2 (CS)>VoWifi (if available). If failure is reported after Sub1 (AUTO), UE would try next entry Sub1 (CS) if during AUTO mode CS RAT is not tried. For certain failure reason (core network reject), the terminal may skip to a different sub (like from Sub1 (AUTO) to Sub2 (AUTO)). Call over VoWIFI (WIFI calling) can be tried if all attempts over cellular failed and VoWIFI is available. Or the terminal could try VoWIFI first then try cellular call.

The embodiments of the present disclosure provide a voice call initiation method. In this method, the terminal may further re-select a SUB/RAT for the voice call when a failure is reported, which can improve successful rate with all possible combination of SUBs/RATs that the terminal supports.

The following is embodiments of the device of the present disclosure, which can be used to implement the method embodiments of the present disclosure. For details not disclosed in the embodiment of the device of the present disclosure, please refer to the method embodiments of the present disclosure.

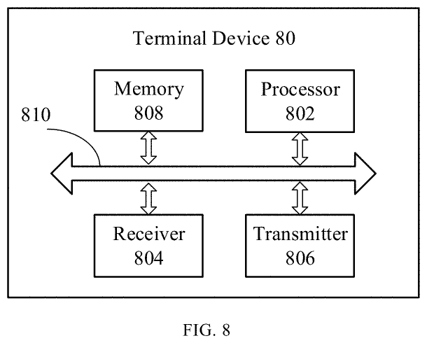

FIG. 7 schematically illustrates a terminal according to an embodiment of the present disclosure. The terminal may be a UE in above-mentioned wireless communication systems.

Referring to FIG. 7, the terminal 70 comprises: a determining unit 701, a selecting unit 702 and an initiating unit 703.

The determining unit 701 is configured to determine a SUB order list with its suitable SUBs and orders of RATs in each SUB.

The selecting unit 702 is configured to select a first SUB for a voice call from the SUB order list in order and a first RAT within the first SUB according to the orders of RATs in the first SUB.

The initiating unit 703 is configured to initiate the voice call with the first SUB and the first RAT.

In an embodiment of the present disclosure, the determining unit 701 is further configured to exclude unsuitable SUB by checking its SIM type or its voice domain capability and order the suitable SUBs by priority in the SUB order list.

In an embodiment of the present disclosure, the determining unit 701 is further configured to determine priorities of the suitable SUBs according to service status of each SUB firstly and then RAT domain of each SUB before ordering the suitable SUBs by priority in the SUB order list.

In an embodiment of the present disclosure, the determining unit 701 is further configured to determine the suitable SUB selected by user has the highest priority when all suitable SUBs have the same service status.

In an embodiment of the present disclosure, the determining unit 701 is further configured to determine the orders of RATs which starts from the current service RAT, within each SUB.

In an embodiment of the present disclosure, the determining unit 701 is further configured to select only one highest priority RAT from each pre-defined group other than the current service RAT, within each SUB.

In an embodiment of the present disclosure, the pre-defined groups include: CS cellular RAT group, PS cellular RAT group and non-cellular RAT group.

In an embodiment of the present disclosure, the CS cellular RAT group includes at least one of the following RATs: WCDMA, TD-SCDMA, GSM and CDMA; the PS cellular RAT group includes at least one of the following RATs: LTE and NR; the non-cellular RAT group includes WIFI.

In an embodiment of the present disclosure, the determining unit 701 is further configured to determine the orders of RATs which starts from the highest priority RAT, within each SUB.

In an embodiment of the present disclosure, RAT priority within each SUB is configured by network device or operator.

In an embodiment of the present disclosure, the determining unit 701 is further configured to determine the orders of RATs which starts from automatic service type RAT first and then follows CS service type RAT, within each SUB.

In an embodiment of the present disclosure, the CS service RAT includes at least one of the following RATs: WCDMA, TD-SCDMA, CDMA and GSM.

In an embodiment of the present disclosure, the selecting unit 702 is further configured to re-select a second RAT and/or a second SUB for retrying the voice call when a failure of the voice call occurs with the first SUB and the first RAT.

In an embodiment of the present disclosure, the selecting unit 702 is further configured to re-select the second SUB from the SUB order list in order when the failure of the voice call occurs with the first SUB and the first RAT.

In an embodiment of the present disclosure, the selecting unit 702 is further configured to select the second RAT within the second SUB according to the orders of RATs in the second SUB.

In an embodiment of the present disclosure, the selecting unit 702 is further configured to re-select the second RAT within the first SUB according to the orders of RATs in the first SUB.

It is important to note that, in the embodiment of the disclosure, the determining unit 701, the selecting unit 702 and the initiating unit 703 may be implemented by a processor (e.g. the processor 802 in FIG. 8).

FIG. 8 schematically illustrates a terminal device according to an embodiment of the present disclosure.

As illustrated in FIG. 8, a terminal device 80 may include a processor 802, a receiver 804, a transmitter 806 and a memory 808, wherein the memory 808 may be configured to store a code executed by the processor 802 as the like.

Each component in the terminal device 80 is coupled together through a bus system 810, wherein the bus system 810 includes a data bus, and further includes a power bus, a control bus and a state signal bus.

The processor 802 typically controls overall operations of the terminal device 80, such as the operations associated with display, data communications and recording operations. The processor 802 may include one or more processors to execute codes in the memory 808. Optionally, when the codes are executed, the processor 802 implements the method performed by the terminal in the method embodiment, which will not be repeated here for brevity. Moreover, the processor 802 may include one or more modules which facilitate the interaction between the processor 802 and other components.

The memory 808 is configured to store various types of data to support the operation of the terminal device 80. Examples of such data include instructions for any applications or methods operated on the terminal device 80, contact data, phonebook data, messages, pictures, video, etc. The memory 808 may be implemented using any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory or a magnetic or optical disk.

The receiver 804 is configured to receive an electromagnetic signal received by the antenna. The main function of the receiver is to select the frequency components it needs from the numerous electromagnetic waves existing in the air, suppress or filter out unwanted signals or noise and interference signals, and then obtain the original useful information after amplification and demodulation.

The transmitter 806 is configured to generate and modulate the RF current and transmit the radio waves through the antenna.

In embodiments of the present disclosure, the transmitter 806 and receiver 804 may be implemented as a transceiver.

The terminal 70 illustrated in FIG. 7 and the terminal 80 illustrated in FIG. 8 may implement each process implanted by the terminal in the abovementioned method embodiments and will not be elaborated herein to avoid repetitions.

Exemplary embodiments have been specifically shown and described as above. It will be appreciated by those skilled in the art that the disclosure is not limited the disclosed embodiments; rather, all suitable modifications and equivalent which come within the spirit and scope of the appended claims are intended to fall within the scope of the disclosure.

What is claimed is:

1. A voice call initiation method, comprising:
determining, by a terminal, a SUB order list with its suitable SUBs;
determining, by the terminal, orders of Radio Access Technologies (RATs) in each SUB;
selecting, by the terminal, a first SUB for a voice call from the SUB order list in order and a first RAT within the first SUB according to the orders of RATs in the first SUB; and
initiating, by the terminal, the voice call with the first SUB and the first RAT.

2. The method as claimed in claim 1, wherein the determining, by the terminal, the SUB order list with its suitable SUBs comprises:
excluding, by the terminal, unsuitable SUB by checking its SIM type or its voice domain capability; and
ordering, by the terminal, the suitable SUBs by priority in the SUB order list.

3. The method as claimed in claim 2, wherein the determining, by the terminal, the SUB order list with its suitable SUBs further comprises:
determining, by the terminal, priorities of the suitable SUBs according to service status of each SUB firstly and then RAT domain of each SUB.

4. The method as claimed in claim 3, wherein the determining, by the terminal, priorities of the suitable SUBs according to service status of each SUB firstly and then RAT domain of each SUB comprises:
determining, by the terminal, the suitable SUB selected by user has a highest priority when all suitable SUBs have a same service status.

5. The method as claimed in claim 1, wherein the determining, by the terminal, the orders of RATs within each SUB comprises:
determining, by the terminal, the orders of RATs which starts from a current service RAT, within each SUB.

6. The method as claimed in claim 5, wherein the determining, by the terminal, the orders of RATs within each SUB further comprises:
selecting, by the terminal, only one highest priority RAT from each pre-defined group other than the current service RAT, within each SUB.

7. The method as claimed in claim 6, wherein the pre-defined groups include: circuit switching (CS) cellular RAT group, packet switching (PS) cellular RAT group and non-cellular RAT group.

8. The method as claimed in claim 7, wherein the CS cellular RAT group includes at least one of the following RATs: Wideband Code Division Multiple Access (WCDMA), Time Division-Synchronization Code Division Multiple Access (TD-SCDMA), Global System for Mobile Communications (GSM) and Code Division Multiple Access (CDMA); the PS cellular RAT group includes at least one of the following RATs: Long Term Evolution (LTE) and new radio (NR); the non-cellular RAT group includes WIFI.

9. The method as claimed in claim 1, wherein the determining, by the terminal, the orders of RATs within each SUB comprises:
determining, by the terminal, the orders of RATs which starts from a highest priority RAT, within each SUB.

10. The method as claimed in claim 9, wherein RAT priority within each SUB is configured by network device or operator.

11. The method as claimed in claim 1, wherein the determining, by the terminal, the orders of RATs within each SUB comprises:
determining, by the terminal, the orders of RATs which starts from automatic service type RAT first and then follows CS service type RAT, within each SUB.

12. The method as claimed in claim 11, wherein the CS service RAT includes at least one of the following RATs: WCDMA, TD-SCDMA, CDMA and GSM.

13. The method as claimed in claim 1, further comprising:
re-selecting, by the terminal, a second RAT and/or a second SUB for retrying the voice call when a failure of the voice call occurs with the first SUB and the first RAT.

14. The method as claimed in claim 13, wherein the re-selecting, by the terminal, the second RAT and/or the second SUB comprises:
re-selecting, by the terminal, the second SUB from the SUB order list in order when the failure of the voice call occurs with the first SUB and the first RAT.

15. The method as claimed in claim 14, wherein the re-selecting, by the terminal, the second RAT and/or the second SUB further comprises:
selecting, by the terminal, the second RAT within the second SUB according to the orders of RATs in the second SUB.

16. The method as claimed in claim 13, wherein the re-selecting, by the terminal, the second RAT and/or the second SUB comprises:
re-selecting, by the terminal, the second RAT within the first SUB according to the orders of RATs in the first SUB.

17. A terminal device, comprising:
a processor; and
a memory configured to store instructions executable by the processor,
wherein the processor is configured to execute a voice call initiation method, the method comprises:
determining, by the terminal device, a SUB order list with its suitable SUBs;
determining, by the terminal device, orders of Radio Access Technologies (RATs) in each SUB;
selecting, by the terminal device, a first SUB for a voice call from the SUB order list in order and a first RAT within the first SUB according to the orders of RATs in the first SUB; and
initiating, by the terminal device, the voice call with the first SUB and the first RAT.

18. The terminal device as claimed in claim 17, wherein the determining, by the terminal device, the SUB order list with its suitable SUBs comprises:
excluding, by the terminal device, unsuitable SUB by checking its SIM type or its voice domain capability; and
ordering, by the terminal device, the suitable SUBs by priority in the SUB order list.

19. The terminal device as claimed in claim 18, wherein the determining, by the terminal, the SUB order list with its suitable SUBs further comprises:
determining, by the terminal, priorities of the suitable SUBs according to service status of each SUB firstly and then RAT domain of each SUB.

20. A non-transitory computer readable storage medium having instructions stored thereon that, when executed by a processor, execute the steps of a voice call initiation method, the method comprises:
determining, by a terminal, a SUB order list with its suitable SUBs;
determining, by the terminal, orders of Radio Access Technologies (RATs) in each SUB;
selecting, by the terminal, a first SUB for a voice call from the SUB order list in order and a first RAT within the first SUB according to the orders of RATs in the first SUB; and
initiating, by the terminal, the voice call with the first SUB and the first RAT.
